(19) United States
(12) Patent Application Publication
(10) Pub. No.: US 2012/0237886 A1
(43) Pub. Date: Sep. 20, 2012

(54) Portable Catalytic Drying Apparatus

(76) Inventors: Jean-Jacques CASSON, TRAMOYES (FR); Daniel AYOTTE, L'assomption (CA); Martin AYOTTE, L'assomption (CA); Jean-Guy LAPOINTE, Repentigny (CA); Jean-Francois BOND, Mont-St-Hilaire (CA); Jacques VILLENEUVE, Longueuil (CA)

(21) Appl. No.: 13/049,319

(22) Filed: Mar. 16, 2011

(51) Int. Cl. F27D 7/02

(52) U.S. Cl. 432/159

(57) ABSTRACT

A catalytic heating apparatus 10 for drying, curing, polymerization and cross-linking of organic coatings and compounds, which includes a catalytic combustion chamber 1, a fuel supply 6, a regulating valve for controlling the flow of fuel 4, an injector for mixing the fuel with air thereby providing a uniform fuel-air mixture to the combustion chamber, a casing 5 connecting the fuel supply to the combustion chamber, and an air injection ring and a connector for connecting an air source to the air injection ring. The air injection ring may be a tube of circular cross-section, with regularly-spaced holes drilled on its surface so as to direct a flow of air towards the object being dried. The purpose of air injection is to facilitate evacuation of vapors from the surface of the object being dried. Drying is therefore achieved by a combination of radiation from the emitting surface and convection from the air injection ring.

### FIELD OF THE INVENTION

The present application relates generally to heating devices, particularly where heat radiated from a catalytic combustion apparatus is used for drying, curing, polymerization and cross-linking of organic coatings and compounds.

### BACKGROUND OF THE INVENTION

There are in the current art apparatuses for the surface emission of infrared radiation, with catalytic combustion of a mixture of a combustible gas (a gaseous hydrocarbon such as propane, natural gas or butane) with an oxidizer gas such as air. Catalysts used in such apparatuses typically include noble metals such as platinum, palladium or rhodium group metals or compounds containing the same. The substrates upon which the catalysts are supported are typically made from refractory fibers.

Generally, a drawback of such known combustion apparatuses is that they are not portable, being rigidly attached to the walls or ceiling of a stationary oven. Under such conditions, pieces to be dried, cured, polymerized or cross-linked must either be placed in the range of the apparatus before treatment starts as in a batch oven, or must be continuously brought into the range of the apparatus as in a tunnel oven. Furthermore, catalytic combustion apparatus currently available contain complex control panels which add substantially to the cost of drying, curing, polymerization and cross-linking.

### SUMMARY OF THE INVENTION

The present invention is generally directed to a catalytic heating apparatus for drying, curing, polymerization and cross-linking of organic coatings and compounds, which includes a catalytic combustion chamber, a support pan for said combustion chamber, a fuel supply, a regulating valve for controlling the flow of fuel, an injector for mixing the fuel with air thereby providing a uniform fuel-air mixture to the combustion chamber, a casing connecting the fuel supply to the combustion chamber, an air injection ring and a connector for connecting an air source to the injection ring. The air injection ring is typically a tube of circular cross-section, with regularly-spaced holes drilled on its surface so as to direct a flow of air towards the object being dried. The purpose of air injection is to facilitate evacuation of vapors from the surface of the object being dried. Drying is therefore achieved by a combination of radiation from the emitting surface and convection from the air injection ring.

In a particular aspect, the apparatus may be installed on a fixed tripod.

In another aspect, the apparatus is small and lightweight enough to be portable and manually handled, used and operated by a single person. In another aspect, the present apparatus iscompletely autonomous. This portability makes it much easier to carry and position the apparatus to, for example, make touch-ups or treat difficult-to-reach parts in automotive paint shops. Furthermore, the apparatus can be attached to a base equipped with piezoelectric means of igniting the fuel-air mixture before the apparatus is used, in such a manner that even if the apparatus is operated inside a hazardous location, for example a Class 1, Division I location, its ignition base remains outside hazardous locations at all times. This provides an advantage because the ignition base does not need to be certified for operation in hazardous locations.

### BRIEF DESCRIPTION OF THE DRAWINGS

FIG. 1 is a side elevation view of an exemplary embodiment of a heating apparatus of the present invention.

FIG. 2 is a side perspective view of an exemplary embodiment of a heating apparatus of the present invention.

FIG. 3 is another side elevation view of an exemplary embodiment of a heating apparatus of the present invention.

FIG. 4 is an exploded view of an exemplary embodiment of the heating apparatus of the present invention.

FIG. 5 is a side elevation view of the ignition base of an exemplary embodiment of the heating apparatus of the present invention.

### DESCRIPTION OF EMBODIMENTS

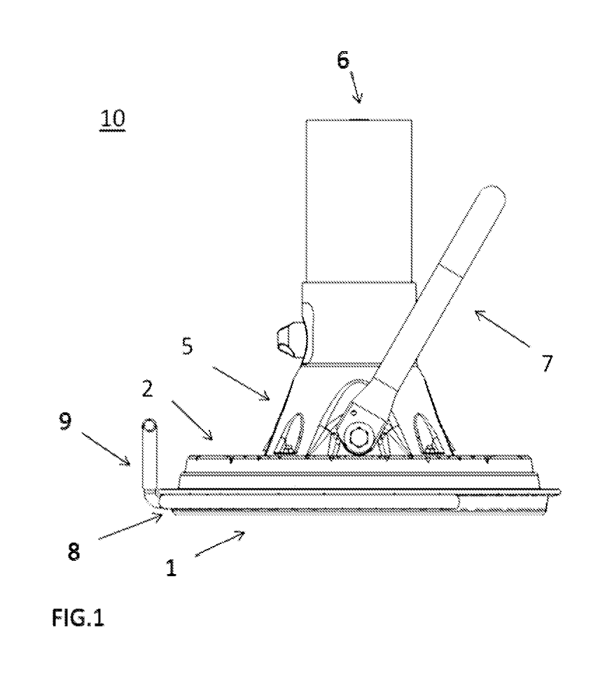

Referring now to FIG. 1, an exemplary embodiment of a heating apparatus 10 of the present invention is shown, in which a fuel such as for example propane, natural gas or butane is supplied under pressure from a fuel canister 6 to a combustion chamber 1 containing a catalyst-containing substrate where the fuel reacts with oxygen. Catalysts used in such devices typically include noble metals such as for example platinum, palladium or rhodium group metals or compounds containing the same. The substrates upon which the catalysts are supported are typically made from refractory fibers. The catalytic substrates generate a flameless combustion with surface emission of infrared radiation in the controlled wavelength range between approximately 2 μm and 10 μm where radiation is most easily absorbed by organic coatings and compounds for the purposes of drying, curing, polymerization and cross-linking. The term “surface emission” should be understood to mean a surface emitting, at every point, infrared radiation, with a calorific emission power distributed homogeneously and uniformly over the entire emitting surface. FIG. 1 also shows an air injection ring 8 and a connector 9 for connecting an air source to the injection ring 8. The air injection ring 8 may be a tube of circular cross-section, with regularly-spaced holes drilled on its surface so as to direct a flow of air towards the object being dried. Injection of air facilitates evacuation of vapors from the surface of the object being dried. Drying is therefore achieved by a combination of radiation from the emitting surface and convection from the air injection ring. The connector 9 may be attached via a “quick-connect” coupling to a compressed air hose fed by the shop air supply. Flow through the injector ring 8 may be adjusted by varying shop air pressure using a pressure regulator.

FIG. 1 also shows a combustion chamber 1, a casing 5 connecting the fuel supply 6 to the combustion chamber 1, and moveable handles 7 and straps (not shown) enabling easy and flexible carrying and positioning. The apparatus is small and lightweight enough to be handled, used and operated by a single person, and may be completely autonomous. In a particular embodiment, the surface of the catalytic combustion chamber is of round shape, of a diameter of 15 inches (381 mm) and of a heating power of 6000 BTU/hr (1.76 kW).

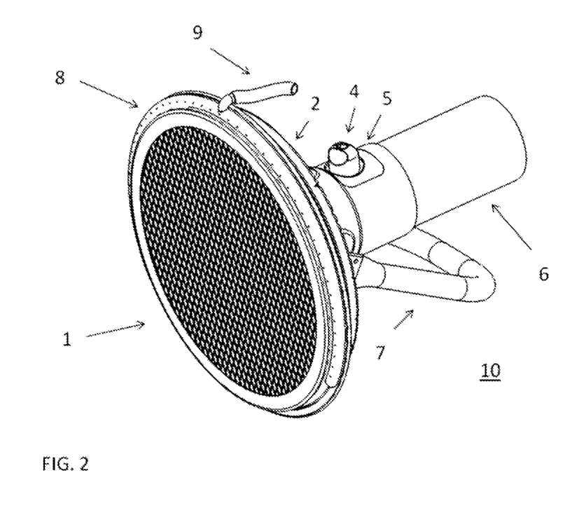

FIG. 2 is a side perspective view of an embodiment of the heating apparatus of the present invention, showing a more detailed view of a front of the combustion chamber 1, of the air injection ring 8 and its connector 9, and showing the location of a regulating valve 4 between the fuel supply 6 and the combustion chamber 1.

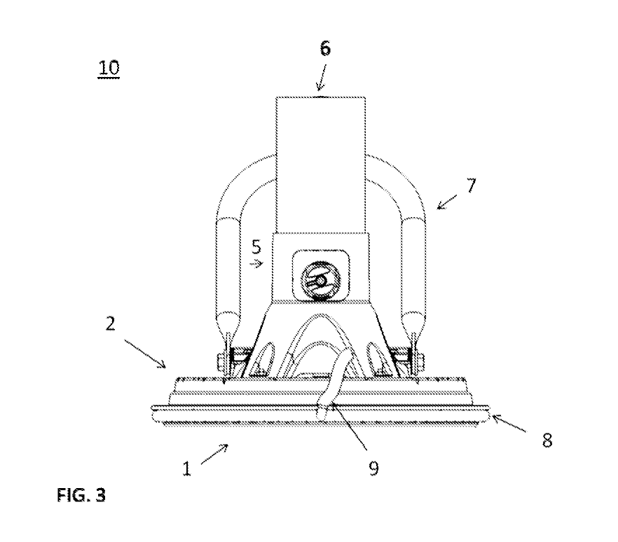

FIG. 3 is another side elevation view of an embodiment of the heating apparatus of the present invention, showing a more detailed view of the regulating valve 4 and the handles 7 attachment.

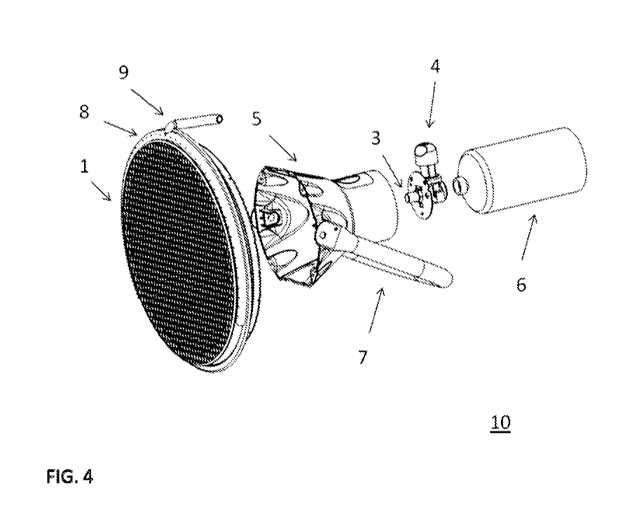

FIG. 4 is an exploded view of an embodiment of the heating apparatus of the present invention. In this exemplary embodiment, the fuel canister 6 is threadedly engaged in the regulating valve 4. The regulating valve 4 comprises a rotary-actuator-controlled, spring-loaded regulator which reduces fuel pressure, for example, to 60 in. w. c. (15 kPa). After discharge from the regulating valve, the fuel enters an injector 3, creating a negative pressure gradient relative to the atmosphere. Air enters injector 3 from one or several holes drilled on its side, and is mixed with the fuel to obtain a mixture of uniform concentration. The fuel-air mixture then proceeds to the combustion chamber 1, where it is combusted on the catalytic substrate contained in the combustion chamber 1 along with secondary air from currents from the exposed surface of the combustion chamber 1. Air is directed towards the material to be dried, cured, polymerised or cross-linked, by the air injection ring 8 fed via the connector 9.

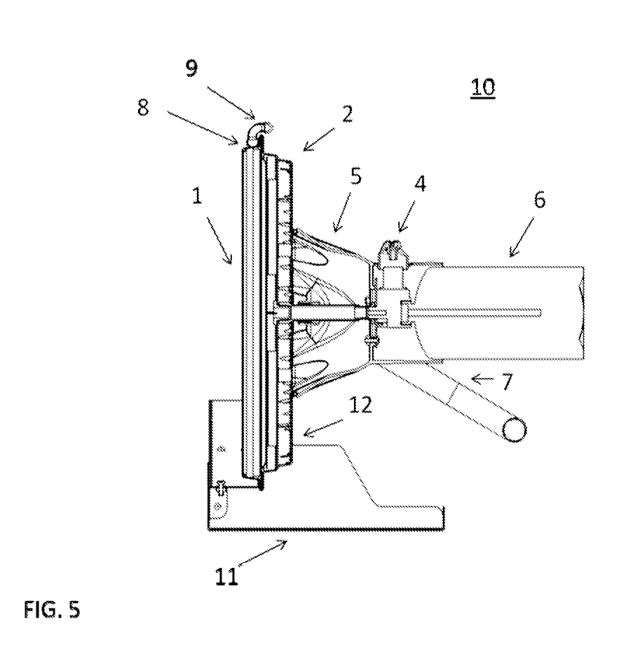

FIG. 5 is a side view of an ignition base of an embodiment of the heating apparatus of the present invention. For lighting, the apparatus is set to rest on notches 11 in the body of base 12. A piezoelectric mechanism on the ignition base (not shown) automatically ignites the heating apparatus.

Although the present invention has been described by means of various embodiments, the present catalytic drying apparatus with air injection is not limited to such embodiments. Many modifications may be performed on the present catalytic drying apparatus with air injection without departing from the scope of the appended claims.

What is claimed is:

1- A catalytic heating apparatus comprising:
a catalytic combustion chamber,
a casing for connecting to a fuel supply and receiving fuel,
a regulating valve for controlling the flow of fuel from the casing to the catalytic combustion chamber,
an injector for mixing the fuel with air thereby providing a uniform fuel-air mixture to the combustion chamber, whereby afterupon ignition of the fuel-air mixture, the catalytic chamber generates heat; and
an air injection ring adapted to receive a flow of air and direct the flow of air towards the object being dried, thereby facilitating evacuation of vapors from the surface of the object being dried and achieving drying by a combination of radiation from the emitting surface and convection from the air injection ring.

2- The apparatus of claim 1, wherein the catalytic heating apparatus is further portable.

3- The apparatus of claim 1, comprising moveable handles and adjustable straps enabling easy carrying and positioning. The apparatus is lightweight enough to be manually handled, used and operated by a single person, and completely autonomous.

4- The apparatus of claim 1, wherein the apparatus can be attached to a base equipped with piezoelectric means of igniting the fuel-air mixture before the apparatus is used, in such a manner that even if the apparatus is operated inside a hazardous location, its ignition base remains outside hazardous locations at all times.
